(19) United States
(12) Patent Application Publication
(10) Pub. No.: US 2008/0154692 A1
(43) Pub. Date: Jun. 26, 2008

(54) System and method for rail yard process monitoring

(76) Inventors: Prescott Logan, Erie, PA (US); David Davenport, Niskayuna, NY (US); John Hershey, Ballston Lake, NY (US); Rahul Bhotika, Albany, NY (US); Kenneth Welles, Scotia, NY (US)

Correspondence Address: DUANE MORRIS LLP, Suite 700, 1667 K Street, N.W., Washington, DC, 20006, US

(21) Appl. No.: 11/984,604

(22) Filed: Nov. 20, 2007

Related U.S. Application Data
(63) Continuation-in-part of application No. 11/374,012, filed on Mar. 14, 2006.

(51) Int. Cl. G06Q 10/00

(52) U.S. Cl. 705/9; 701/117; 705/7

(57) ABSTRACT

A system and method for planning and monitoring rail yard processes and performance including compiling historical information, real time status display of rail yard activity, the development of parameters and metrics to evaluate rail yard performance, collection of rail yard status from various sensors, and the planning and assigning of work tasks for enhanced productivity and car processing capability.

This application is a continuation in part of U.S. application Ser. No. 11/374,012, titled “A System and Method Of Rail Yard Planning” filed Mar. 14, 2006, the disclosure of which is hereby incorporated by reference.

The present disclosure is directed to a system and method for rail yard process monitoring.

In North America, the main competitor against the rail industry is the trucking industry. The most significant hurdles for the rail industry in capturing more of the North Atlantic market are reducing transit time and reducing transit time variability. Rail yard operations are central to any effort to reduce transit time and transit time variability. Rail yards account for upwards of fifty percent of total car transit time and transit time variation. Typically, thirty five to fifty percent of all carloads endure one or more yard-based switch events per trip. For the remaining carloads, mainline fluidity is contingent upon yards receiving and departing trains as scheduled. As a result, on-time train departure performance is approximately forty to eighty percent and car connection performance is approximately thirty to seventy percent. These levels of performance typically result from a lack of coordination among yard activities. Poor planning is endemic in the yard because of the inherent complexity of the equation that the planner is attempting to solve in order to perfectly synchronize the operation. Because of his limitations, the planner typically reaches a sub optimal solution, which results in poor utilization of yard resources and ultimately underperformance (relative to some theoretical capability). The nature of yard operations, i.e. a highly variable inflow and the occurrence of catastrophic events, makes planning more difficult some days than others. Also, there is significant variability in each yardmaster's ability to solve the planning equation.

A rail yard consists of a number of sub yards with each sub yard designed to perform specific tasks. Before a train enters a rail yard, the train is typically under the control of a network movement plan generated by a line-of-road planner and executed by a dispatcher. As the train enters the rail yard, the responsibility for the movement of the train is passed from the dispatcher to rail yard personnel. The rail yard personnel will control the movement of the train pursuant to a rail yard movement plan. The rail yard movement plan is different than the line of road movement plan in that the line of road movement plan considers a train as a single entity and plans the use of resources to move the train without conflict through the rail network. In the rail yard, the train consist will be divided into individual cars and thus the rail yard movement plan must account for the individual movement of each of the cars and locomotive until a reconstituted train having different cars is released from the rail yard to the line of road movement planner. Typically, the movement plan for the rail yard had been generated manually to take into account the various services and resources that are required to process the incoming cars.

One typical configuration of a rail yard includes a receiving yard for receiving a train from a network of tracks. The receiving yard includes one or more sets of track to receive a train from the line of road tracks and permit rail yard personnel to inspect the train. The locomotives are detached from the railcars and further inspection and maintenance is accomplished. Railcars are then moved from the receiving yard to classification tracks. The railcars are classified in blocks of common destination. The classification yard can be either a flat-switched classification yard (requiring a motive force) or a hump yard. The hump yard typically includes a hill which feeds into a set of classification tracks to allow individual rail cars to be gravity fed to the appropriate classification track as a function of the destination of the railcar. Cars having a common destination are fed to a common track. A series of switches down stream of the hump control the track to which the car is routed. Once the railcars are classified in blocks, they are moved as blocks to the departure yard. The departure yardmaster directs each block to a departure track based on its subsequent destinations. At the departure yard, the cars are inspected and the train consist is brake tested and powered up and prepared for release to the network of line of road track under control of the dispatcher. Although larger yards may have dedicated tracks used for receiving, classifying and departing railcars and trains, some yards use common tracks to perform the required tasks and do not have tracks dedicated to a specific purpose, e.g., common tracks are used for receiving and classifying.

Typically, the scheduling of train movement in the yard is largely a manual effort including (a) estimating train arrival time by conferencing with line-of-road operations management officials, (b) negotiating between line-of-road and yard officials about the time at which each train will be accepted by the yard, (c) allocating a set of receiving tracks to an inbound train based on intuition and static business rules communicated by word of mouth, (d) assigning workers to inbound car inspection tasks, reporting completion of inspection tasks, and requesting new assignments by physically reporting to the responsible yard manager, in-person, or by radio, (e) selecting a track or tracks to combine and hump, (f) communicating humping tasks to the hump engine crew in-person, or via radio, (g) coupling and pulling selected cars to the hump approach lead, (h) shoving selected cars over the hump at a prescribed rate, (i) planning trim and pull-down operations to move the classified car blocks from their classification tracks to the departure tracks in preparation for departure, (j) manually communicating trim and pull-down assignments to switch engine crews, in-person or via radio, (k) reporting completion of trim and pull-down assignments, in-person or via radio, (l) scheduling power and crew assignments to each outbound train, (m) assigning workers to outbound car inspection and departure preparation tasks, reporting completion of inspection tasks, and requesting new assignments by physically reporting to the responsible yard manager, in-person, or by radio, and (n) adjusting departure time estimates based on reported, estimated and/or actual resource availability times (e.g. crew and engine), and task completion times. Because many of these tasks are performed by yard personnel who report to the yardmaster only upon completion of their assigned task, a common problem is the excessive dwell time of the railcars while waiting for the required tasks of inspecting and servicing to be completed by yard personnel.

A rail yard serves to process cars carried by inbound trains. Arriving cars are inspected, classified and sorted into blocks of cars. Blocks of cars are then grouped and coupled to locomotives for transport to the next destination along the rail network. A rail yard may be considered to be similar to a manufacturing plant. As such, application of manufacturing automation concepts and techniques presents an opportunity to enhance rail yard productivity and efficiency. However, the rail yard is unique from traditional manufacturing facilities. Within the rail yard, the raw materials (rail cars, locomotives) used to build the products (outbound trains) do not follow a deterministic path to each of the work stations. The assembly paradigm does not apply to a rail yard as the workers flow to the raw material. Furthermore the final product, an outbound train, is built by combining its elements rail cars, in many different embodiments. Further the outbound train may be incomplete (missing cars) or with extra components. The problem is to apply process automation monitoring and sensing components to the rail yard to facilitate improved productivity and capacity with respect to processing of rail cars and building trains.

The present disclosure provides a system and method for monitoring rail yard processes and performance. The disclosure includes wireless and wired network interfaces to a central monitor and database. The database compiles historical performance data reflecting rail yard task completion and capability. In addition to historical data, the monitoring computer affords real-time status display of rail yard activity, tasks and progress of the tasks. The rail yard monitor system collects parameters related to rail yard operations including locomotive servicing, rail cars, crew maintenance processes, train arrival, train building, and train departure. Parameters collected serve to reflect the temporal evolution and level of effort, i.e., complexity of yard operations and tasks. The rail yard monitor system captures parameter inputs from various sensors and interfaces throughout the rail yard. These parameters are combined in the formulation of metrics which indicate progress towards completion and productivity of operational tasks and processes within the rail yard. This system and method affords a global view of yard work and status for each rail yard operations group in order to efficiently plan and assign work tasks for enhanced productivity and car processing capability.

Another aspect of the present disclosure is a versatile user interface which permits the yard flow process to be visualized through interactive displays.

These and many other objects and advantages of the present disclosure will be readily apparent to one skilled in the art to which the disclosure pertains from a perusal of the claims, the appended drawings, and the following detailed description of the embodiments.

### BRIEF DESCRIPTION OF THE DRAWINGS

FIG. 1 is a simplified pictorial representation of one embodiment of the present disclosure.

FIG. 2 is a simplified flow diagram illustrating the operation of the embodiment of FIG. 1.

FIG. 3 is a simplified pictorial representation of one embodiment of a display screen for use with the present disclosure.

FIG. 4 is a simplified pictorial representation of another embodiment of a display screen for use with the present disclosure.

FIG. 5 is a simplified pictorial representation of another embodiment of a display screen for use with the present disclosure.

### DETAILED DESCRIPTION

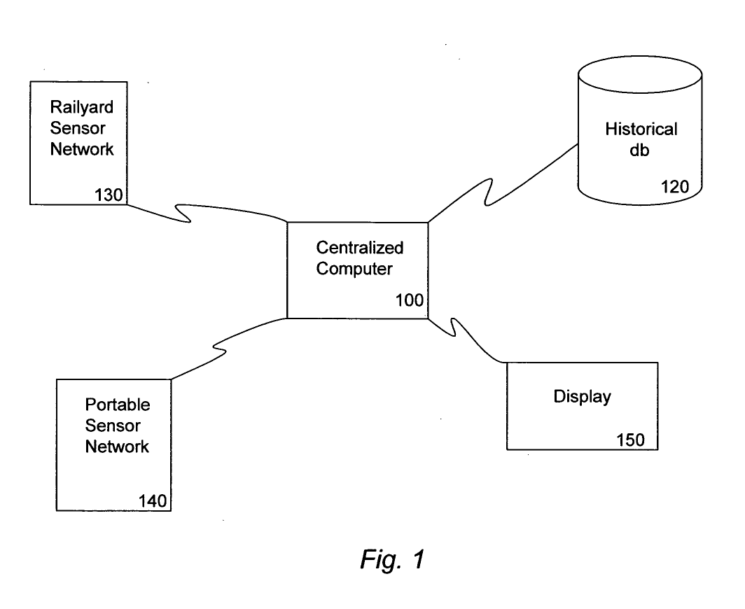

With reference to FIG. 1, an automated rail yard monitoring system includes a central computer 100, and a database 120. The centralized computer 100 receives input from a rail yard sensor network 130 and a portable sensor network 140. The sensor networks may identify temporal events in the yard. The rail yard sensor network 130 can include well known sensing mechanisms which may be used to measure, capture and quantify activities in the yard. For example AEI tag readers, wheel detectors, cut-light sensors and track circuits are well-known to the rail signaling community and can be installed to indicate the passage of an engine, locomotive and a rail car by a fixed location. These sensors can be utilized to detect and record temporal events automatically or based on user input, including, but not limited to (a) time at which a locomotive couples to one or more railcars, (b) time at which a locomotive uncouples from one or more rail cars, (c) time at which crew is transported to outbound locomotive; (d) time at which crew boards outbound locomotive. Other sensors may include electronic imaging devices, video devices, location detection devices, position sensors, gravity sensors, and coupler sensors Sensor networks suitable for operation with the present disclosure are described in the following commonly owned patents and applications: U.S. Pat. No. 6,637,703 titled “Yard tracking System”; U.S. patent application Ser. No. 11/318,338, titled “Apparatus And Method For Locating Assets Within A Rail Yard”; U.S. patent application Ser. No. 11/317,533, titled “System and Method For Monitoring Train Arrival And Departure Latencies”; U.S. patent application Ser. No. 11/317,570, titled “Monitoring Status of Railroad Equipment Using Wireless Sensing Devices”; U.S. patent application Ser. No. 11/317,067, titled “System and Method for Determining Whether A Locomotive Or Rail Engine is Coupled To A Rail Car Or Other Engine” and U.S. patent application Ser. No. 11/471,156, titled “Intelligent Multi-Camera Rail Yard Monitoring System”; all of the disclosures of which are incorporated by reference herein.

The centralized computer also receives input from portable sensors carried by rail yard personnel that provides the current status of activities in the yard including inspections, repairs and/or maintenance. One such portable sensor device that may be suitable is described in commonly owned U.S. patent application Ser. No. 11/785,904, titled “Enhanced Recordation Device For Rail Car Inspections”, the disclosure of which is incorporated by reference, herein.

Information from rail yard sensor network 130 and portable sensor network 140 may be stored in database 120 to develop historical data models for rail yard resources. Rail yard resources may include yard crews, yard power available, yard power in use, yard tracks, etc. The centralized computer 100 can evaluate the input from rail yard sensor network 130 and portable sensor network 140 or the historical data models from the database to develop parameters that are characteristic of the rail yard productivity and efficiency. These parameters may include (a) utilization of specific receiving yard tracks occupied by rail cars from an inbound train, (b) number of rail cars pulled from classification yard or receiving yard, (c) utilization of an engine over a specific period of time e.g., hour, day, or week, (d) number of rail cars repaired per day by the car repair facility, (e) dwell based on shift, day, or week (f) execution vs. plan based on shift, day, or week, (g) performance based on specific train types, line-up types and time windows.

Using combinations of parameters reflecting temporal events and level of effort, the present disclosure formulates metrics for tracking the status and progress towards completion of specific yard processes, e.g., work tasks. Work tasks may include arrive, inbound inspect, hump/switch, build, outbound inspect and depart. These process metrics may be presented to rail yard personnel in real time, as well as stored in database 120 for analysis at a later time.

Computer 100 may contain programmed functionality of an optimizer. The optimizer can determine the best sequence of events in the yard, based on a selectable goal. For example, a selectable goal may be minimize the cumulative hours of dwell. Another goal may be to minimize costs, or to maximize throughput, maximize train use, maximize on time performance, etc. Another goal may be to optimize the plan with respect to worker safety. For example, such an optimization would generate alerts or prevent scheduling of tasks which may increase risk to worker safety, i.e., where receiving a train on a track adjacent to one where a car inspection is active. The optimizer may be responsible for the whole yard plan or just a portion of the yard plan. For example optimizer may plan classification track usage based on projected train make-up, departure times, arrival times, build times, empty class tracks, default class make-up, lead orientation at the build end, inbound and outbound train make up.

By way of another example, the optimizer may look at the next 8 humps, either inbound or outbound, and determine the best hump sequence, based on how far out the train is, how the class will look, number of connections made, percentage of trains filled, hours of dwell, etc.

The optimizer may provide an optimal plan and allow the user to make adjustments to the plan through interactive display 150. Optimizer may produce plans with varying levels of detail. For example, in one embodiment, optimizer may produce a plan which identifies the sequence of events for all trains in a selectable planning horizon. In another embodiment, optimizer may produce a plan which identifies which tracks to hump first, which trains to brake test first, which trains to arrive first, on which track to be inspected by which crew, which train to build first, on which track, to include which cars, which inbound and outbound tracks to use, which traffic in the class to take, which traffic outside the class to take, etc. The user has the option to accept and execute the plan, or to provide modifications to the plan through display 150.

The optimizer will be in communication with historical database and can predict planned usage down to different layers of granularity. For example, the optimizer may plan based on the average of trains of similar class, or based on specific train make with specific yard crew.

Computer 100 may contain programmed functionality of a simulator. The simulator simulates various plans and their impacts on the yard's operation. For example, the simulator can advance the clock ahead and look at the impacts of the plan adjustment. The simulator has the ability to simulate resource change, track structure or outage changes, weather changes and determine impacts on business targets of any given plan. For example, the simulator can create simulations to determine the costs of:

humping a car based on car type
switching a car based on type,
arriving and departing a train
mechanically testing a train
under utilizing or over utilizing a crew
adding another crew to handle volumes
reducing a crew
running heaters in cold weather when the humps slows down
running a trim engine

In one embodiment the present disclosure includes a wireless network communicating between a centralized computer and various rail yard resources including rolling stock, distributed sensors, and handheld devices. For example, crew members may be provided with a portable tracking device that they may carry from their reporting for duty through their transport to the departure yard where they place their portable on the dashboard of the engine to track the activities of the crew. At the next yard, the dashboard-tracking device is left by the crew and retrieved by the service shop personnel where it can be downloaded to database 120 via central computer 100. In this manner the portable tracking device serves to track crew activities as well as locomotive location and movement within the yard. Because the portable tracking device can be used in any location, it does not require the entire fleet of locomotives be fitted with a tracking device.

The monitored parameters and formulated metrics discussed above can be stored in database 120 for analysis, trending, prediction, what-if analysis and establishment of nominal thresholds for individual processes to identify delays or bottle neck processes. For example, if one of the monitored parameters is number of rail cars repaired by the repair facility per day, a threshold may be determined based on an analysis of historical performance data above which the repair facility introduces excessive dwell time to the cars utilizing the repair facility. Yard personnel can then take action to alleviate the excessive dwell, e.g., increase repair personnel or delay sending additional cars to repair facility.

Thus the present disclosure provides automated monitoring of rail yard processes related to crews, rail cars, locomotives and building of outbound trains. Such a monitoring system provides real-time and historical data enabling yard personnel to efficiently plan and execute operational tasks. Anomalous occurrences can be rapidly identified and remedial actions taken to improve the short term performance as well as long term efficiency of the yard.

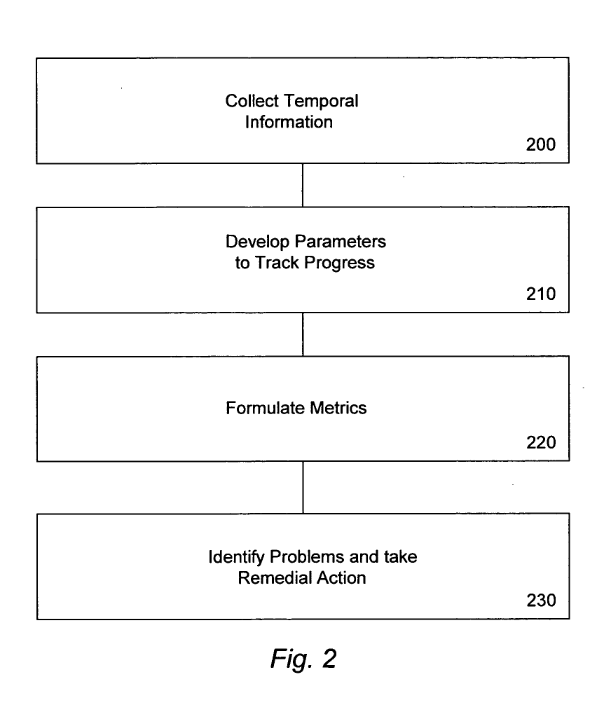

With respect to FIG. 2, a high level flow diagram of the present disclosure is described. First sensor information is collected 200 regarding real-time progress in the yard. The collected sensor data represents temporal events occurring in the yard. The sensor data can be analyzed to provide parameters which may be used to quantify the activity in the yard 210. For example, the locations of rail cars can be collected as a function of time for a specific task, e.g., inbound inspection. The location of the inspectors as a function of time conducting the inspection may also be collected. Based on the collected temporal information a parameter can be developed 210 which can assist in the tracking of the progress of the task. For example, the length of the train may affect the time to complete the inspection, but the relationship may not be linear. Next metrics can be formulated 220 which can be used to predict and track the progress of the rail cars in the yard. For example, a metric can be developed such that a train in excess of some threshold length would be identified as requiring some remedial action to be taken, i.e., additional inspectors assigned, in order that excessive dwell time does not occur. Thus, by formulating metrics, the progress of the rail yard can be tracked and problems can be identified early and remedial action can be taken 230.

A database 120 of historical data allows data mining to be performed to produce metrics and provide reports. Information that can be collected and reported includes classification yard metrics, crew performance metrics, and plan performance metrics. Classification yard metrics includes:
Class condition to include # of slough tracks, # or misroutes, skewed dynamic class condition, accuracy of actual hump execution vs. planned execution, congestion, etc. . . .
Number of cars left behind on train departure
Average length of time in class
Percentage of day that class is spent in active use
   Crew performance metrics include:
Performance measurement based on the crew that executed the plan
Performance measurement of all crews down to the individual level
Percentage of time that a given crew is used
Number of cars processed per given crew
Percentage of time that a given crew is in motion vs. planned usage
   Plan performance metrics include:
Dwell variance between proposed plan and locked-in plan
Dwell variance between proposed plan and executed plan
Variance in percentage of trains filled out and fill percentage
Variance in class yard performance
Variance in total cars through
Variance in percentage of resources used

Database 120 may also receive information from other yards in order to create a robust and comprehensive historical database which would provide additional confidence as to process capability.

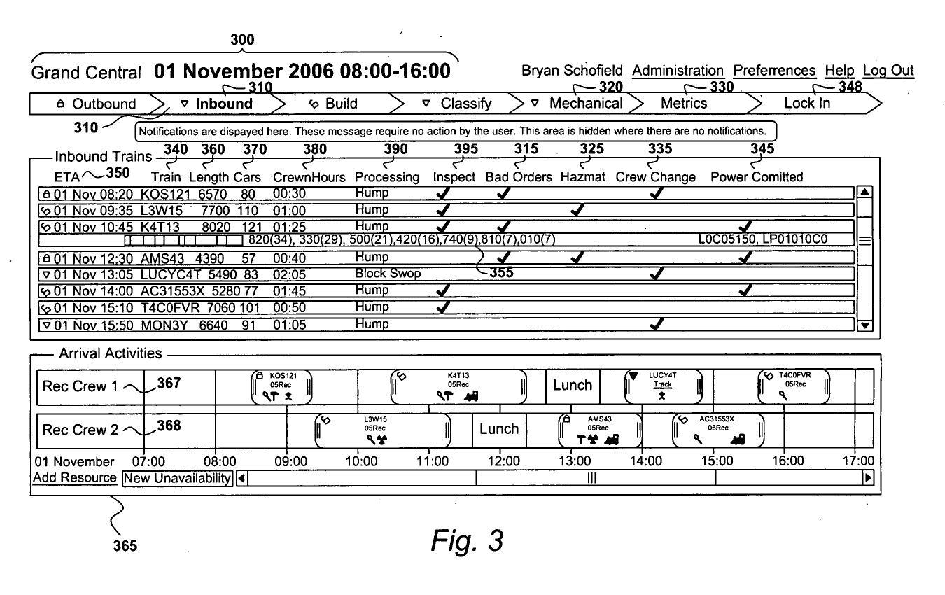

While some prior art systems have attempted to collect performance data, none of the systems make the collected information available to a user to plan future movement through the yard. FIG. 3 is one embodiment of a user display 150. Planning bar 300 identifies the standard processes that each train in the yard is expected to utilize. The planning bar 300 may be organized in standard temporal sequence; however the operator may select any of the processes for display. In the example in FIG. 3, the inbound process 310 is selected. The planning bar 300 may also contain links to non-planning screens such as mechanical 320, metrics 330 and locking 340.

The planning screen for the inbound process 310 includes the identification 340 and estimated time of arrival 350 of trains entering the yard for a selectable planning horizon. Physical characteristics, such as the length 360 and the number of cars 370 may be included as well as crew information such as the number of hours for the current crew 380. Processing 390 for each train 340 as well as inspections 395 to be performed can be indicated. Trains that have a bad order 315 or hazardous materials 325 can be indicated, as well as trains that require a crew change 335. Where trains have been assigned locomotives 345, this may also be indicated. When an inbound train is selected 355, the row can expand to reveal more details such as the train make-up.

A portion of the inbound display can identify the arrival activities displayed as a function of crew availability 365. In this example, two receiving crews, 367 and 368 are available. The display is interactive in that an inbound train can be selected, and using well known drag and drop technology can be assigned an available receiving crew. Historical information for each crew can be stored in database 120, and made available to computer 100 to estimate the time required for the receiving crew to perform its task. For example, the estimated time can be based on the specific receiving crew. The estimated time can also be based on the specific make-up of the train. Access to the historical data makes the planned activities more accurate than the prior art, and the arrival activities displayed can use historical data analyzed by computer 100.

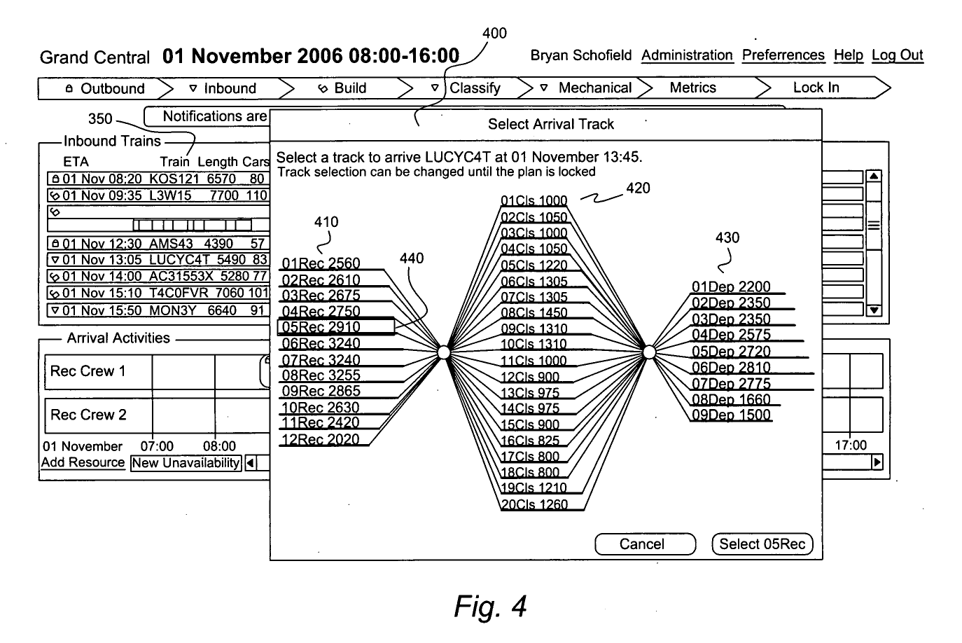

FIG. 4 is an example of selecting a track for an inbound train. From the arrival activities display of FIG. 3, once a receiving crew is assigned 365 to a train (LUCYC4T in this example) a receiving track can be assigned with the interactive display of FIG. 4. Track selection screen 400 provides available tracks for receiving 410, classifying 420 and departing 430, as a function of the selected train 350. In this example, receiving tracks 1-12 are available and receiving track 5, 440, has been selected. Once selected, the arrival activity display 365 of FIG. 3 would be automatically updated to show that LUCYC4T has been assigned to receiving track 5.

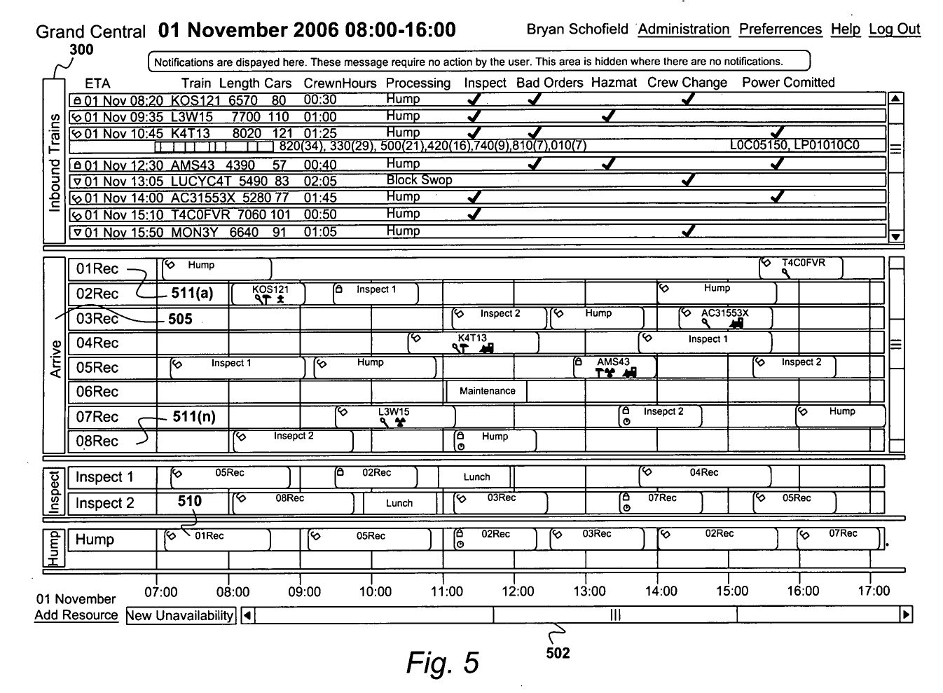

FIG. 5 is one embodiment of an interactive display for visualizing and controlling the flow through the yard.

The display provides a functional time strip of the receiving yard 505 identifying each of the receiving tracks 511(a)-(n), and the planned usage/availability of the tracks. The display is fully interactive in that the inbound trains 300 may be assigned to the receiving yard using drag and drop technology. A portion of the display may be used to schedule and monitor the actions of the yard personnel. For example, inspection teams 525 can be identified and their proposed schedule for the planning horizon 502 can be displayed. Interactivity, such as drill down technology can be used to identify the current personnel assigned to the inspection teams, or to monitor the actual progress of the inspection teams throughout the day. For example, by clicking on inspection team 1 at 8:00 am on receiving track 5 510, a displayed can be provided which details the real time progress of the inspection and can display parameters such as percentage of completion, aggregate time, etc. Moreover, computer 100 may monitor actual execution of the task vs. the planned execution of the task and provide an alert when the deviation exceeds a predetermined threshold. For example, if the actual inspection lags the planned inspection but a predetermined amount block 510 can flash red to provide a visual indication to the user that the inspection may take longer than planned and allow the user to take remedial action such as extend the time for the inspection or dedicate additional resources tot the inspection. Such early warning may allow the user to take remedial action before the delay impacts other work task in the yard.

The predetermined thresholds may be based on the metrics determined by computer discussed previously and can be selected based on the historical performance data. For example, it may be determined that if an actual inspection deviates more than 18 minutes from the planned inspection, a train will not be able to adhere to its scheduled inspection and the receiving track will not be available for its next scheduled usage.

The display 150 may use a variety of colors, flashing indicators, and pop-ups to alert users to various changes or discrepancies. Alerts may be generated based on performance metrics discussed previously. Alerts may be based on deviation from the plan, resource issues such as too many tasks occurring with too few crews, trains not filled out, excessive class yard volumes, or yard volumes in excess of arrival or departure tracks. Drill-down technology may be utilized to allow double clicking on an alert to display more detail regarding the alert. The detailed alert allows the user to determine exactly what part of the plan has fallen behind or moved ahead and allows the user to determine what other parts of the plan will be affected by the alerted change. Thus the alerts helps identify for the user whether they need to re-plan and help identify which specific part of the plan needs adjustment, and may also provide alerts to other users and departments.

Processes, such as hump 535, can be displayed for the planning horizon 502 and can tracked in real-time using drill down technology. Thus the full status of the yard can be provided to the yard manager in a real-time interactive display of track resources, yard resources for a selectable planning horizon.

The display may provide full interactivity by allowing the operator to drag train to track, or to drag track to train to create an arrival activity. The display areas for inbound trains 500, arrival tracks 505, inspection crews 525 and hump yard 535 are fully linked so that multiple activity boxes are created and linked so that the resources are appropriately reserved. For example, the train on receiving track 4 is scheduled to be inspected by team 1 from 1345-1530. Receiving track display 505 shows that inspection team 1 will be inspecting receiving track 4 during this period 545. Also during this same period, the inspection team display 525 shows that team 1 will be inspecting receiving track 4 555. Thus a change to one display area will automatically change the display for any linked resources, allowing the operator to completely evaluate the impact of any scheduling decisions to all yard resources.

The display also provides instantaneous feedback to the operator in the form of alerts when scheduling conflicts are identified. Also the display may provide alerts when a selected resource is scheduled in excess of that which was required based on metrics that have been identified using historical data. For example, alerts can be generated based on deviations form the scheduled plan. Alerts may also be based on resource utilization issues, i.e., too many events occurring with too few of crews or not enough arrival or departure tracks for plan.

The information displayed can also be collected and analyzed to produce individual and yard performance measurements. For example, standard reports on productivity can be based on shift in each yard, by day and by week. An analysis on dwell, execution vs. plan, and performance based on specific train types, lineup types and time windows may help establish default values for future planning sessions. The default values can be used by an optimizer to establish an optimal plan and then allow user through the display to make adjustments to the plan.

Embodiments of the subject matter and the functional operations described in this specification can be implemented in digital electronic circuitry, or in computer software, firmware, or hardware, including the structures disclosed in this specification and their structural equivalents, or in combinations of one or more of them.

Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine-generated electrical, optical, or electromagnetic signal that is generated to encode information for transmission to suitable receiver apparatus for execution by a computer. The computer readable medium can be a machine-readable storage device, a machine-readable storage substrate, a memory device, a composition of matter affecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personnel digital assistant (PDA), a mobile audio or video player, a game console, a Global Positioning System (GPS) receiver, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While preferred embodiments of the present disclosure have been described, it is understood that the embodiments described are illustrative only and the scope of the disclosure is to be defined solely by the appended claims when accorded a full range of equivalence, many variations and modifications naturally occurring to those of skill in the art from a perusal hereof.

What is claimed:

1. In a rail yard having a plurality of arriving trains, and a plurality of resources in which to process the trains through the rail yard, a method of planning the movement of a train through the rail yard comprising the steps of:
a. displaying a plurality of arriving trains;
b. selecting one of the displayed arriving trains;
c. displaying one or more available tracks as a function of the selected train;
d. selecting one of the available tracks;
e. displaying one or more processes to be performed on the selected train;
f. selecting one of the displayed processes;
g. planning the movement of the selected train on the selected track as a function of the selected process; and
h. displaying the planned movement of the selected train as a function of the selected track and the selected process.

2. The method of claim 1 wherein the step of planning the movement further comprises:
(i) accessing a database having historical information for the selected process;
(ii) estimating the time to perform the selected process; and
(iii) displaying the planned movement as a function of the estimated time.

3. The method of claim 1 further comprising:
i. monitoring the actual movement of the selected train;
j. comparing the actual movement of the selected train with the planned movement of the selected train; and
k. displaying an alert when the actual movement deviates from the planned movement by a predetermined amount.

4. The method of claim 3 wherein the selected track is a receiving track and the selected process is inspection.

5. The method of claim 1 wherein
the step of displaying one or more processes to be performed includes displaying one or more crews to perform the process, and
the step of selecting one of the displayed processes includes selecting one of the displayed crews

6. The method of claim 5 wherein the step of planning the movement further comprises:
(i) accessing a database having historical information for the selected crew;
(ii) estimating the time for the selected crew to perform a process; and
(iii) displaying the planned movement as a function of the estimated time.

7. The method of claim 1 wherein the selected track and selected process is displayed as not available to other trains during the planned movement.

8. The method of claim 3 wherein the predetermined amount is determined by the steps comprising:
(a) accessing a database having historical information for the selected process; and
(ii) calculating a predetermined amount as a function of the accessed historical information for the selected process.

9. The method of claim 1 wherein the steps of selecting comprise at least one of double clicking on the display or drag and drop technology.

10. In a rail yard having an arriving train with a plurality of railcars, and a plurality of resources in which to process the railcars through the rail yard to build a plurality of departing trains, a method of planning the movement of the railcars through the rail yard comprising the steps of:
a. collecting historical data relating to the movement of railcars through a rail yard;
b. developing parameters to track the progress of the processes performed on the railcars based on the collected historical data;
c. determining metrics which quantitize the developed parameters;
d. planning the movement of the railcars through the yard as a function of the collected historical data;
e. monitoring the actual movement of the railcars through the yard;
f. comparing the actual movement of the railcars with the determined metrics; and
g. providing an alert when actual movement exceeds a determined metric by a predetermined threshold.

11. The method of claim 10 wherein the developed parameters comprise at least one of performance of a crew, performance of a class yard, and dwell variance.

12. The method of claim 10 wherein the collected historical data is maintained in a database.

13. The method of claim 10 where the planned movement of the railcars is displayed, and wherein the provided alert is displayed on a user monitor.

14. The method of claim 13, wherein the user may modify the planned movement in response to the alert by using the display.

15. The method of claim 14 wherein the modification may be made using drag and drop technology.

16. The method of claim 10 wherein the step of collecting historical data comprises collecting data from one or more sensors selected from the group of AEI tag readers, wheel detectors, cut-light sensors, track circuits, imaging devices, gravity sensors and location sensors.

17. The method of claim 16 wherein the one or more sensors are portable and carried by rail yard personnel.

18. The method of claim 10 wherein the step of collecting historical data comprises collecting data from sensors using wireless communication links.

19. The method of claim 10 wherein the step of collecting historical data comprises collecting data from a second rail yard.

20. The method of claim 10 wherein the determined metrics relate to plan performance and include at least one of dwell variance between proposed plan and locked-in plan, dwell variance between proposed plan and executed plan, variance in percentage of trains filled out and fill percentage, variance in class yard performance, variance in total cars through, and variance in percentage of resources used.

21. The method of claim 10 wherein the determined metrics relate to crew performance and include at least one of number of cars processed per crew per unit time, percentage of time a crew is used, time remaining before end of a crew shift.

22. The method of claim 10 wherein the determined metrics relate to classification yard performance and include at least one of average length of time car spends in classification yard, percentage of day that classification yard track is in use, number of cars left behind on train departure, number of car misroutes, accuracy of hump plan, number of slough tracks.

23. The method of claim 10 where the determined metrics relate to yard switch engine performance and include at least one of number of rail cars pulled from receiving yard versus time, number of rail cars pulled from classification yard versus time, engine utilization over 8 hours.

24. The method of claim 10 where the determined metrics relate to railcar repair and include at least one of time to repair versus repair code, capacity of repair tracks.
